(19) United States
(12) Patent Application Publication
(10) Pub. No.: US 2025/0366395 A1
(43) Pub. Date: Dec. 4, 2025

(54) DEVICES, SYSTEMS, AND METHODS FOR ENHANCED ROBOTIC MANIPULATION AND CONTROL

(71) Applicant: L5 Automation Inc., La Canada Flintridge, CA (US)

(72) Inventors: Alexander Gutierrez, La Canada Flintridge, CA (US); Edward Terry, La Canada Flintridge, CA (US); Daniel Schneider, San Jose, CA (US); Alex Lee, La Canada Flintridge, CA (US); Sarah Lozano, Chino, CA (US); Robert Beetem, Seattle, WA (US)

(21) Appl. No.: 18/875,932

(22) PCT Filed: Jun. 15, 2023
(86) PCT No.: PCT/US2023/068514

§ 371 Date: Dec. 17, 2024

Related U.S. Application Data
(60) Provisional application No. 63/353,274, filed on Jun. 17, 2022.

(51) Int. Cl. A01D 46/30; B25J 5/00; B25J 9/16; G06V 20/68

(52) U.S. Cl. CPC A01D 46/30; B25J 5/00; B25J 9/1697; G06V 20/68

(57) ABSTRACT

Arrangements for enhanced robotic manipulation and control are provided. A system may include a mobile robot including a sensor generating sensor data indicative of a physical attribute of an object of interest, and a robotic arm including an actuator causing the robotic arm to move relative to the object of interest. The object of interest may be detected based on received sensor data. It may be determined whether the object of interest meets or exceeds a first threshold based on the sensor data. Accordingly, a label associated with a keypoint of the object of interest based on the sensor data may be generated. An orientation and scale of the object of interest in the environment relative to the robotic arm may be determined based on the label. Accordingly, a motion plan for the robotic arm may be generated. The robotic arm may be caused to perform the motion plan.

### PRIORITY CLAIM

The present application claims priority to U.S. Provisional Patent Application No. 63/353,274, titled DEVICES, SYSTEMS, AND METHODS FOR ENHANCED ROBOTIC MANIPULATION AND CONTROL, filed Jun. 17, 2022, the disclosure of which is incorporated by reference in its entirety herein.

### BACKGROUND

Current techniques for autonomously controlling a robotic device struggle to replicate the precision enabled by a human's hand-eye coordination—a degree of precision that can be easy to take for granted. For example, it can be difficult for robots to autonomously orient themselves within the physical world based on sensor alone, due to limitations to the sensor data as well as limitations to the device's processing capabilities based on sensor data. Robotic control can be even more difficult when trying to sense objects of interest in the real world, where such objects can be obscured by their environment. Moreover, the problem is exacerbated when the robot requires a more delicate interaction with the object of interest. Conventional strawberry picking robots, for example, might be capable of simply detecting a strawberry and removing it from a plant but would struggle to pick strawberries that are obscured by canopy or bunched in clusters that include un-ripened berries. Additionally, conventional robots are incapable of orienting themselves relative to a strawberry in order to executed a series of motions that pick the strawberry in an optimal way.

### SUMMARY

In one general aspect, the present disclosure is directed to a camera-based plant analysis system that uses machine learning, computer vision, and artificial intelligence to enhance the manipulation and control of a robotic crop picker. The plant analysis system can include a robotic arm, an imaging device and a back-end computer system. The imaging device can be configured to traverse a field or farm via a vehicle (e.g., an autonomous vehicle) and generate sensor (e.g., image) data associated with plants. The imaging device can be further configured to transmit the captured image to the back-end computer system, which is configured to autonomously detect objects of interest within the sensor data, characterize the detected objects of interest, and transmit the characterized data back to the robot for enhanced understanding and control relative to the crops. The system can further understand whether certain crops are obscured by foliage as well as the age and ripeness of the crops. Accordingly, the robot can realize the benefits of human-like hand-eye coordination and discernment when picking the crops. These and other benefits realizable through aspects of the present invention will be apparent from the description that follows.

In another general aspect, the present disclosure is directed to a system for enhanced robotic manipulation and control relative to an object of interest within an environment. The system can include a robot configured to navigate the environment. The robot can include a sensor configured to generate sensor data associated with the object of interest, and a robotic arm that includes an actuator, wherein the actuator is configured to cause the robotic arm to move relative to the object of interest. The system can further include a computer system communicably coupled to the robot. The computer system can include a processor and a memory configured to store an algorithm that, when executed by the processor, causes the computer system to receive sensor data generated by the sensor, detect the object of interest based on the sensor data, determine whether the detected object of interest meets or exceeds a first threshold based on the sensor data, generate a label associated with a keypoint of the object of interest based on the sensor data, upon determining that the object of interest meets or exceeds the first threshold, determine an orientation and scale of the object of interest in the environment relative to the gripper based on the generated label, generate a motion for the robotic arm based on the determined orientation and scale of the object of interest, and control the actuator of the robotic arm such that the robotic arm performs the generated motion.

In yet another general aspect, the present disclosure is directed to a computer system configured to enhance manipulation and control of a robot. The computer system can include a processor communicably coupled to the robot and a memory configured to store an algorithm that, when executed by the processor, causes the computer system to receive sensor data generated by a sensor of the robot, detect an object of interest based on the sensor data, determine whether the detected object of interest meets or exceeds a first threshold based on the sensor data, generate, upon determining that the object of interest meets or exceeds the first threshold, a label associated with a keypoint of the object of interest based on the sensor data, determine an orientation and scale of the object of interest in the environment relative to the gripper based on the generated label, generate a motion for the robot based on the determined orientation and scale of the object of interest, and cause the robot to perform the generated motion.

### FIGURES

Various embodiments are described herein by way of example in connection with the following figures, wherein:

FIG. 1 illustrates a block diagram of a system configured for enhanced robotic manipulation and control, in accordance with at least one non-limiting aspect of the present disclosure;

FIG. 2 illustrates a block diagram of a non-limiting application of the system of FIG. 1, in accordance with at least one non-limiting aspect of the present disclosure;

FIG. 3 illustrates a flow diagram of an algorithmic method executed by the back-end computer system of the system of FIG. 1, in accordance with at least one non-limiting aspect of the present disclosure;

FIG. 4 illustrates a flow diagram of the segmentation labeling step of the algorithmic method of FIG. 3, in accordance with at least one non-limiting aspect of the present disclosure;

FIG. 5 illustrates a flow diagram of the attribute labeling step of the algorithmic method of FIG. 3, in accordance with at least one non-limiting aspect of the present disclosure;

FIGS. 6A-C illustrate several views of sensor data generated by the system of FIG. 2 and attenuated via the method of FIG. 3, in accordance with at least one non-limiting aspect of the present disclosure;

FIG. 7 illustrates more sensor data generated by the system of FIG. 2 and attenuated by the method of FIG. 3, in accordance with at least one non-limiting aspect of the present disclosure;

FIG. 8 illustrates a reference chart illustrating various training data for the back-end computer system of the system of FIG. 2, in accordance with at least one non-limiting aspect of the present disclosure;

FIG. 9 illustrates more sensor data generated by the system of FIG. 2 and attenuated by the method of FIG. 3, in accordance with at least one non-limiting aspect of the present disclosure;

FIGS. 10A-D illustrate more sensor data generated by the system of FIG. 2 and attenuated by the method of FIG. 3, in accordance with at least one non-limiting aspect of the present disclosure; and

FIGS. 11A-D illustrate several block diagrams depicting an enhanced motion and control of the robotic arm and gripper of the robot of FIG. 2, in accordance with at least one non-limiting aspect of the present disclosure.

### DESCRIPTION

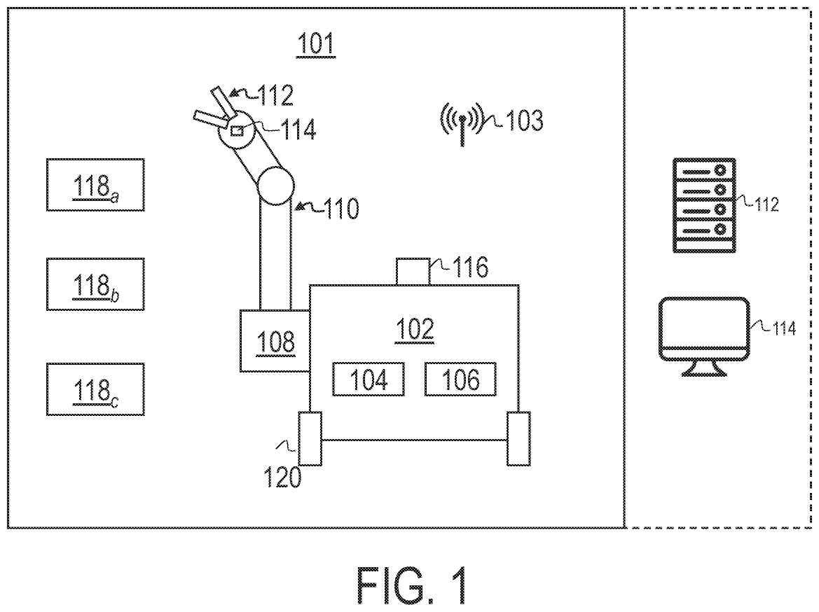

Referring not to FIG. 1, a block diagram of a system 100 configured for enhanced robotic manipulation and control is depicted in accordance with at least one non-limiting aspect of the present disclosure. According to the non-limiting aspect of FIG. 1, the system 100 can include a robot 102 configured to traverse an environment 101 and sense and/or interact with one or more objects of interest 118_{a-c}. As depicted in FIG. 1, the robot 102 can include one or more wheels 120 configured to assist in the traversal of the environment 101. For example, the robot 102 of FIG. 1 can be configured as or mounted to a ground-based vehicle. However, according to other non-limiting aspects, the robot 101 can be configured as or mounted to any vehicle (e.g., aircraft, watercraft, spacecraft, etc.) configured to traverse any environment in any number of ways (e.g., air, water, space, etc). The vehicle can comprise propulsion means, such as an electricity or gas-powered motor, and steering means (e.g., hydraulic, electronic) for traversing the environment 101.

Still referring to FIG. 1, the robot 102 can include an on-board processor 104 with an associated on-board memory 106 configured to store instructions that, when executed by the processor 104, command the robot 101 to perform any number of actions within the environment 101. The robot 102 can further one or more actuators 108 mechanically coupled to one or more robotic arms 110. An actuator 108, for example, can be communicably coupled to the processor 104 such that the processor can control the actuator 108 and thus, the robotic arm 110. The robotic arm 110 can further include one or more grippers 112 configured to grab or otherwise interact with one or more objects of interest 118_{a-c} within the environment 101. The memory 106 can also include software instructions that, when executed by the processor 104, allow the processor 104 to navigate the environment 101 by controlling the propulsion and steering means. In other embodiments, the robot 102 could be human-navigated or navigated by remote control.

Additionally, the robot 102 of the system 100 of FIG. 1 can include one or more sensors configured to detect the one or more objects of interest 118_{a-c} within the environment 101. For example, a first sensor 114 can be mounted to the robotic arm 110 and/or a second sensor 116 can be mounted to a body portion of the robot 102, itself. The first sensor 114 and second sensor 116 can include a camera, a light detection and ranging (“LIDAR”) sensor, an ultrasonic sensor, a radio detection and ranging (“RADAR”), and/or any other form of electromagnetic sensor, light sensor, sound sensor, proximity sensor, and/or temperature sensor that could prove useful in detecting the one or more objects of interest 118_{a-c}. The camera(s), if employed, can be a hyperspectral, high-resolution (e.g., 1-10 megapixels), digital (e.g., a charge-coupled device (CCD) sensor or Complementary Metal Oxide Semiconductor (CMOS) sensor-based camera.

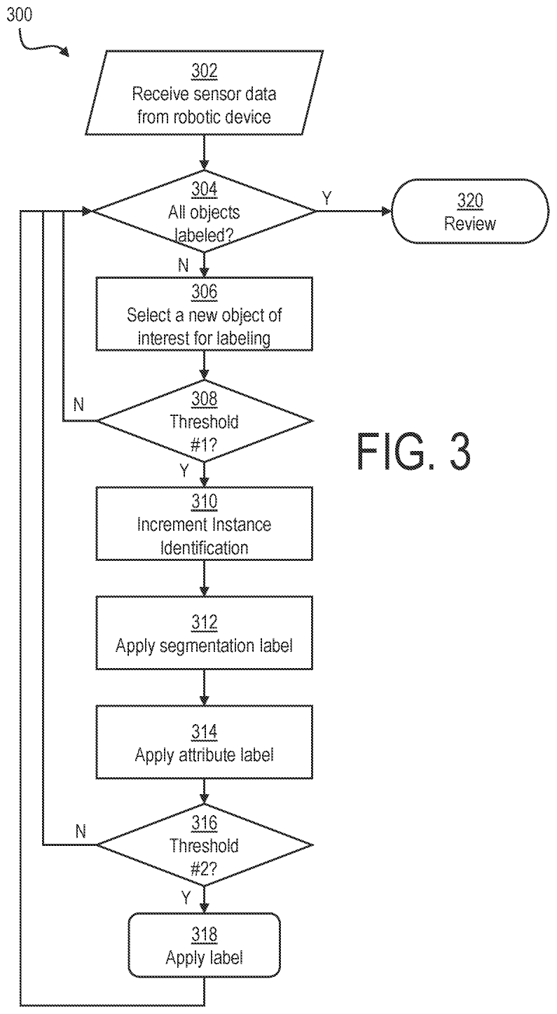

In further reference to FIG. 1, the system 100 can further include a back-end computer system 112, a display 114, and a wireless access point 103, or any other means of establishing wireless data communication between components of the system 100 (e.g., between the robot 102 and the back-end computer 112), regardless of whether those components are internal or external to the environment 101. For example, the wireless access point 103 of FIG. 1 can be configured to broadcast a wireless infrastructure network such as WiFi® or a cellular network. However, according to other non-limiting aspects, various components of the system 100 can be configured to communicate with each other via one or more ad hoc networks, such as Bluetooth® and/or near-field communication (“NFC”) techniques. Additionally and/or alternately, information can be extracted from the robot 101 and stored on a local memory device, such as a thumb drive, and plugged into the back-end computer system 112 for processing, for example, in accordance with the method 300 of FIG. 3.

According to the non-limiting aspect of FIG. 1, the back-end computer system 112 can be remotely located relative to the environment or locally positioned within the environment. Alternatively and/or additionally, according to other non-limiting aspects, the processor 104 of the robot 102 can be configured to perform the processing functions of the back-end computer system 112. That is, in other words, the back-end computer system 112 could be on-board the robot 102. Furthermore, it shall be appreciated that the display 114 of FIG. 1 can include any stand alone display, the display of a laptop computer, and/or the display of a mobile device, such as a smart phone or tablet computer, so long as the display 114 is communicably coupled to the server 114 and/or processor 104 of the robot 102.

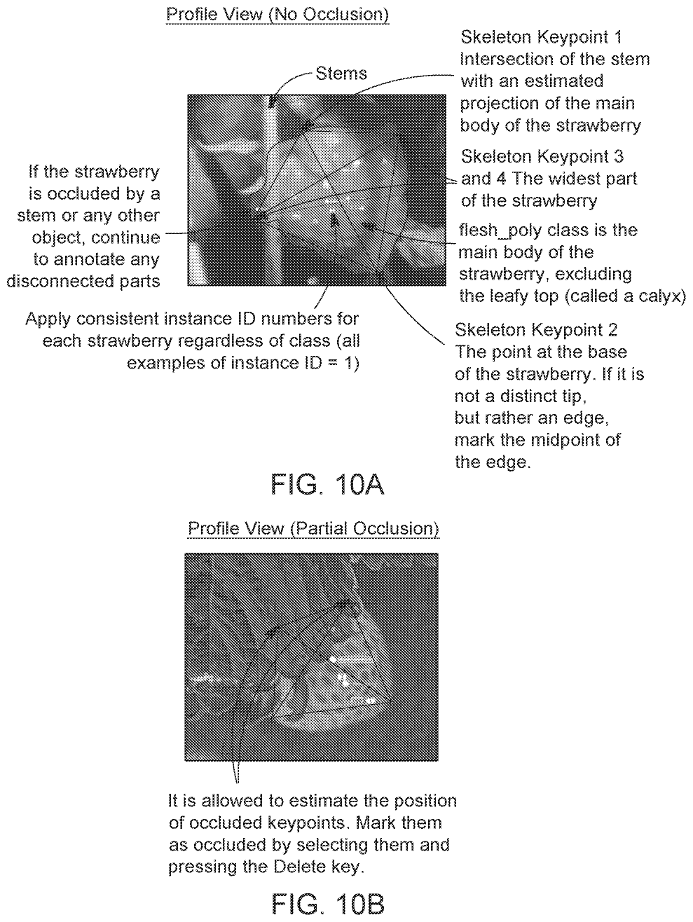

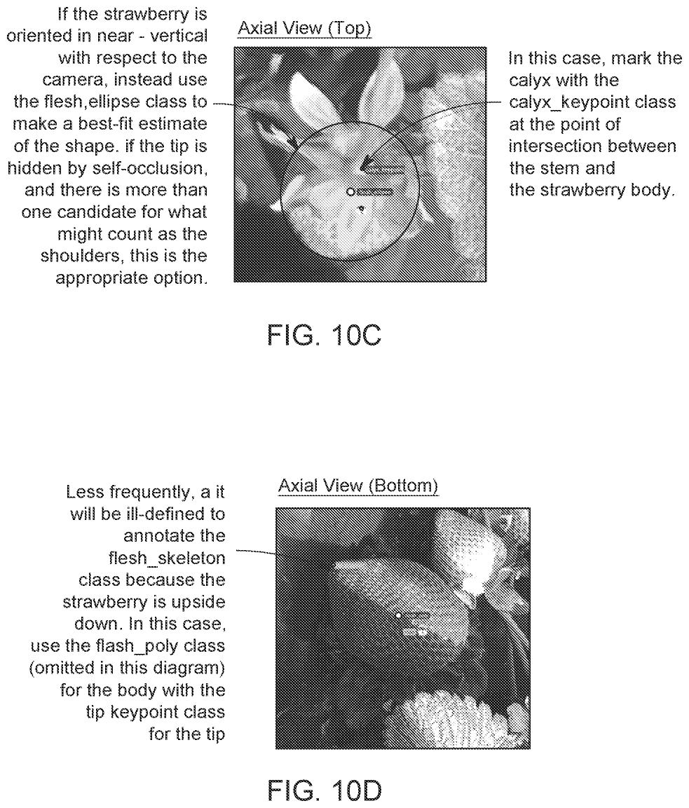

As will be described in further reference to FIGS. 10A-D, the system 100 can be configured for enhanced robotic manipulation and control by generating data using sensors 114, 116, processing the generated sensor data via certain algorithmic methods 300, which model dynamics and control, such that the robot 102 can interact with one or more objects of interest 118_{a-c} within the environment 101 with an enhanced precision that simulates a human's hand-eye coordination. Accordingly, the robot 102 of system 100 can utilize data generated by the sensors 114, 116 in an improved manner, which enables the use of a lower cost robotic arm 110 without the need for cost-prohibitive, high-precision motors and/or encoders. In other words, the system 100 of FIG. 1 enables the use of lower cost hardware because it enhances how data generated by the sensors 114, 116 is processed.

According to other non-limiting aspects, the system 100 can further include one or more light emitting devices (not shown) and/or shields (not shown) configured to alter a lighting condition within the environment 101. As such, the light emitting devices (not shown) and/or shields (not shown) can alter the lighting condition to enhance sensor data generated by the first sensor 114 and/or the second sensor 116 and thus, improve inputs and processing performed by the on-board processor 104 and/or the back-end computer system 112. For example, the light emitting devices (not shown) and/or shield (not shown) can be used to produce a constant, known illumination about the robot 102 and/or objects of interest 118_{a-c}, which can enhance processing of sensor data. Alternately, the light emitting device (not show) can produce active lighting conditions (e.g., strobing, structured light, structure from shadow, etc.), which can enhance depth inferences from how light and/or shadows move within the environment 101. This can reduce the number of sensors 114, 116 required to move throughout the environment 101.

For example, according to some non-limiting aspects, one or more sensors 114, 116 can include a hyperspectral camera, which can be sued to more readily distinguish objects of interest 118_{a-c} within the environment 101 and thus, reduce the time for the labor-intensive manual pixel-perfect labeling process using cues in the visible spectrum alone, as would otherwise be required by the back-end computer system 112. Additionally and/or alternatively, inter-frame tracking can be implemented, according to some non-limiting aspects, to achieve enhanced in-depth treatment. For example, motion cues can be implemented, via known sensor 114, 116 movement and/or optical flows, with appearance cues (e.g., neural network embedding vector, etc.) to associate new and pre-existing detections by the sensors 114, 116.

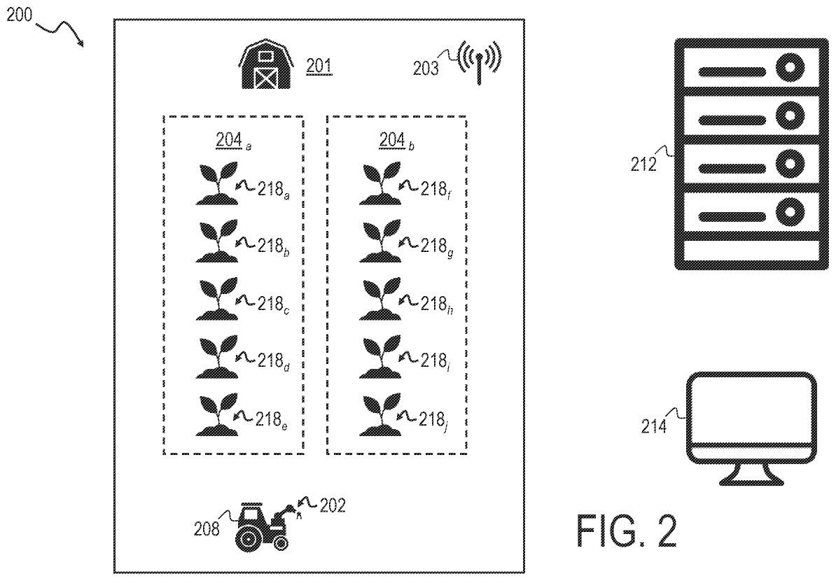

Referring now to FIG. 2, a block diagram of a non-limiting application 200 of the system 100 of FIG. 1 is depicted in accordance with at least one non-limiting aspect of the present disclosure. According to the non-limiting aspect of FIG. 2, the environment can include a farm 201 and the objects of interest can include a plurality of strawberry plants 218ₐ₋ⱼ arranged in one or more beds 204ₐ, 204_{b}. A robot 202, similar to the robot 102 of FIG. 1, is depicted as having a robotic arm and gripper mounted to a tractor 208 configured to traverse the farm between the beds 204ₐ, 204; for strawberry 218ₐ₋ⱼ inspection, picking, and packaging. Of course, even within the application 200 of FIG. 2, other objects of interest can be sensed and/or interacted with. For example, according to other non-limiting aspects, the robot 202 can sense and interact with a bed, a plant, a furrow, a sprinkler, other farming/irrigation equipment, the robot itself, other robots within the environment 201, ditches, poles, specific flowers, wheels, packaging (e.g., cartons, boxes), juice trays, debris in the bed (e.g., paper, plastic bags, tape, etc), weeds, animals (e.g., bugs, birds, etc), and/or eggs, amongst other objects of interest, or disinterest, depending on user preference and/or intended application.

As described in reference to the system 100 of FIG. 1, the robot 202 of FIG. 2 can include one or more sensors, an onboard processor, and/or memory configured to enable the autonomous, robotic control of the robotic arm. In other words, the robot 202 can generate sensor data associated with the strawberries 218ₐ₋ⱼ as it traverses the farm 201. Additionally, the robot 202 of FIG. 2 can be configured to communicate with a back-end computer system 212 and a display 214, which can be remotely located relative to the farm 201. In other words, the robot 202 can send the back-end computer system 212 sensor data associated with the strawberries 218ₐ₋ⱼ, the back-end computer system 212 can process the data in accordance with the method 300 of FIG. 3, and in turn generate instructions according to which the robot 202 manipulates its robotic arm and gripper to interact with the strawberries 218ₐ₋ⱼ with enhanced precision. Alternately and/or additionally, an onboard processor of the robot 202 can process the generated sensor data without the need for a back-end computer system 212.

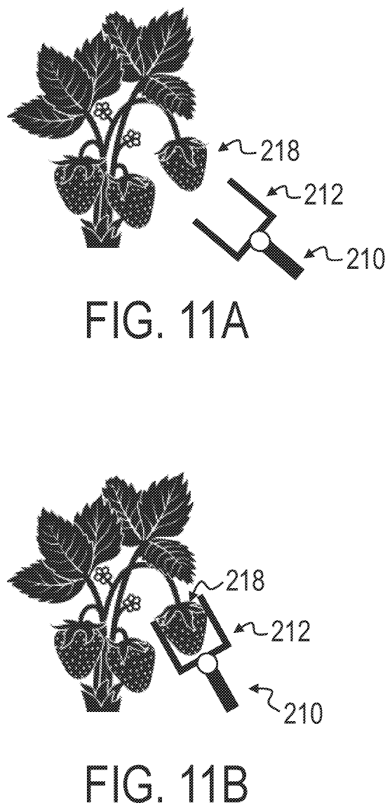

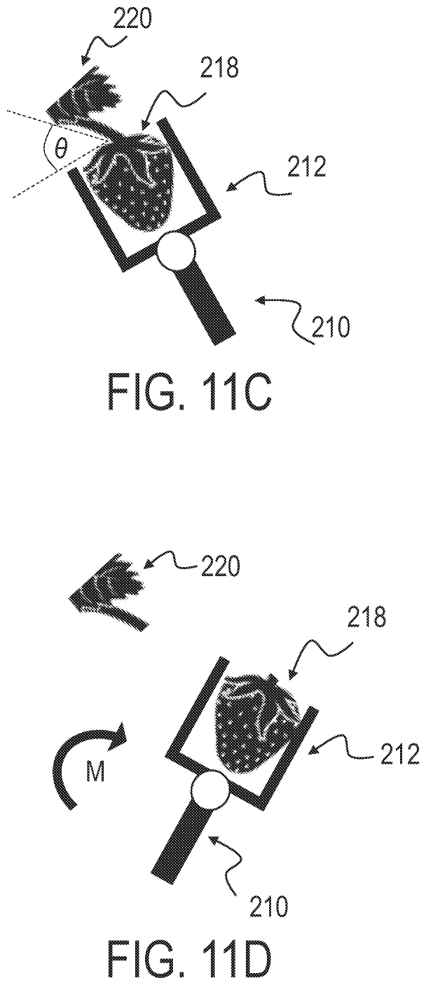

Although the application 200 of FIG. 2 involves robotic strawberry 218ₐ₋ⱼ picking, it shall be appreciated that strawberry 218ₐ₋ⱼ picking is merely presented as an illustrative example of how the system 100 of FIG. 1 can be applied to enhance robotic manipulation and control for jobs that are difficult for conventional robots and systems. Specifically, strawberry 218ₐ₋ⱼ picking can require robotic manipulation and control of objects that are either immature, unripe, and/or occluded by foliage. Moreover, as will described in further detail with reference to FIGS. 11A-D, the robot 202 can be configured to interact with (e.g., pick) the strawberries in an optimal way, assuming it is able to identify and understand its position relative to each strawberry 218ₐ₋ⱼ, as enabled by the algorithmic method 300 of FIG. 3.

Referring now to FIG. 3, a flow diagram of an algorithmic method 300 executed by the back-end computer system 212 of the system of FIG. 2 is depicted in accordance with at least one non-limiting aspect of the present disclosure. However, as previously discussed, the method 300 can be executed by an on-board processor (e.g., processor 104 of FIG. 1) of the robot 202, according to other non-limiting aspects. According to the non-limiting aspect of FIG. 3, the method 300 can include receiving, at step 302, sensor data generated one or more sensors (e.g., first sensor 114, second sensor 116, etc.). The sensor data can be received via an access point, such as access point 203, or can be stored on a local memory device, such as a thumb drive, and plugged into the back-end computer system 212 for processing. For example, where a sensor (e.g., first sensor 114, second sensor 116, etc.) is a camera, the sensor data can include images of the environment 201 and/or objects of interest, which according to the non-limiting aspect of FIG. 2, are strawberries 218ₐ₋ⱼ.

In further reference to FIG. 3, once the sensor data is received, the method 300 can include detecting strawberries 218ₐ₋ⱼ within the received sensor data and determining, at step 304, whether all objects of interest 218ₐ₋ⱼ within the received sensor data have been labeled. For example, strawberries 218ₐ₋ⱼ can be labeled using any of a number of annotation tools, such as KeyPoint, CVAT, LabelIMG, labelme, VoTT, VGG Image Annotator, imglab, Supervisely, ImageTagger, and/or LabelFlow, amongst others. Specifically, one or more keypoints, or key components and/or features, associated with objects of interest within the sensor data can be labeled and processed to assess a scale and/or orientation of each object of interest, or strawberry 218ₐ₋ⱼ, relative to the robot 202. Specifically, once the keypoints are labeled the back-end computer system 212 can use each keypoint to contextualize the received sensor data, which may include the pixels of captured image data. In this way the back-end computer system 212 can assess how the strawberries 218ₐ₋ⱼ are oriented within the environment 201 relative to the robot 201. If all strawberries 218ₐ₋ⱼ are labeled, the method 300 calls for the transmission of the sensor data, including all labeled keypoints, for review.

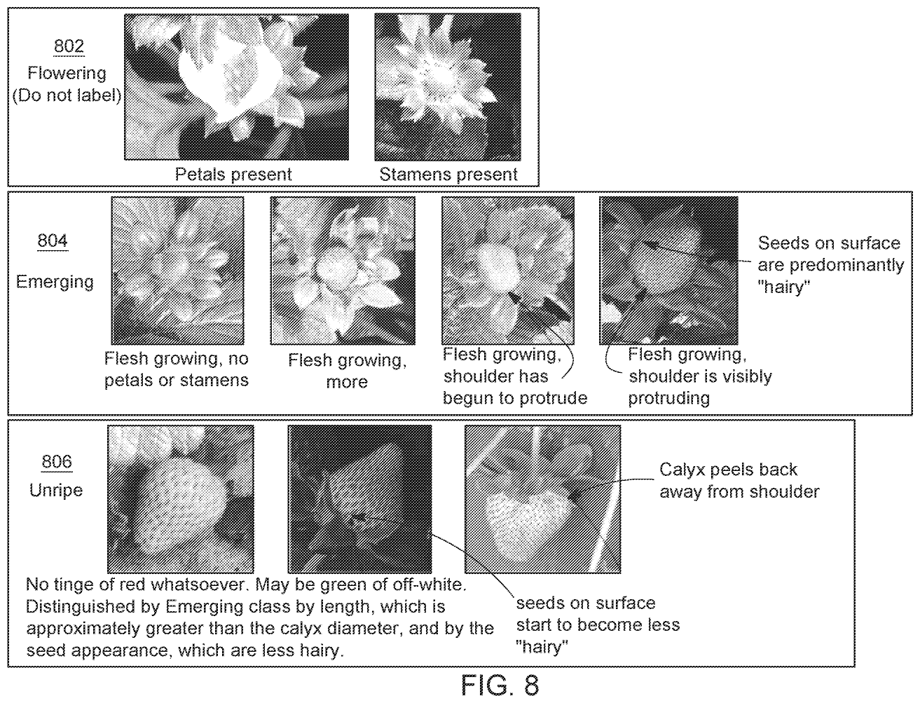

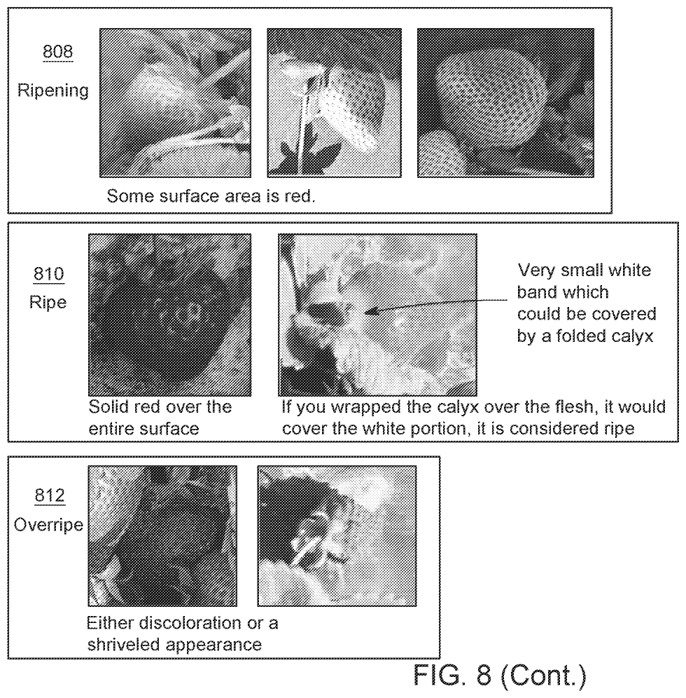

However, according to the non-limiting aspect of FIG. 3, if all of the strawberries 218ₐ₋ⱼ in the sensor data do not include labeled keypoints, then the back-end computer system 212 will select, at step 306, a new object of interest, or strawberry 218ₐ₋ⱼ, for labeling. Upon selecting a strawberry 218ₐ₋ⱼ, for labeling, the back-end computer system 212 will assess, at step 308, whether the strawberry 218ₐ₋ⱼ meets or exceeds a first threshold criteria. For example, according to the non-limiting aspect of FIG. 3, where the objects of interest are strawberries 218ₐ₋ⱼ, the back-end computer system 212 may assess 308 whether or not the unlabeled strawberry 218ₐ₋ⱼ of interest is emerging/turning or ripe, in accordance with a predetermined criteria, such as those presented in FIG. 8 (e.g., illustrative charts 802, 804, 806). As used herein, the term “turning,” shall include strawberries that are ripening from white to red, increasing in ripeness until they are fully red. In other words, the back-end computer system 212 may assess 308 whether or not the unlabeled strawberry 218ₐ₋ⱼ of interest exceeds a ripeness threshold. Of course, the method 300 can be attenuated such that the assessed threshold, at step 308, is adjusted to include any other characteristic associated with a strawberry 218ₐ₋ⱼ of interest. Moreover, according to still other non-limiting aspects where the objects of interests are not strawberries, the assessed 308 threshold can be tailored to include any other characteristic relevant to any specific object of interest, in accordance with user preference and/or intended application.

If the strawberry 218ₐ₋ⱼ fails to meet or exceeds the first threshold criteria, the back-end computer system 212 will conclude that no labeling of the features of the strawberry 218ₐ₋ⱼ is required, and reassess, at step 304, whether any additional labeling is required. If not, the sensor data is transmitted, at step 306, for review. In other words, the back-end computer system 212 can determine that the strawberry 218ₐ₋ⱼ is emerging and not ripe and thus, does not require labeling.

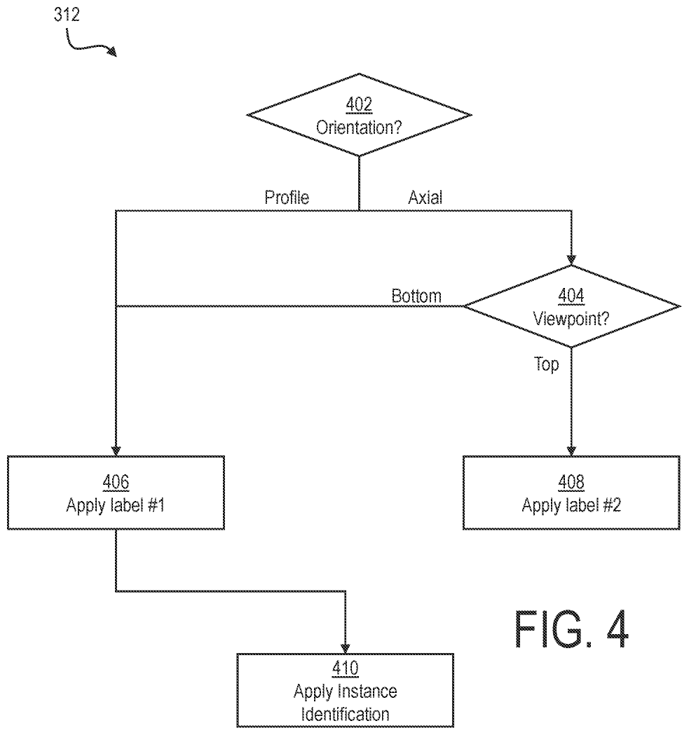

According to the non-limiting aspect of FIG. 3, assuming the strawberry 218ₐ₋ⱼ meets or exceeds the first threshold criteria (e.g., is not emerging but is ripe), the method 300 can further include incrementing, at step 310, one or more instance identifiers. For example an instance identifier can differentiate one keypoint-or any other component of the sensor data—from another. Each time new sensor data is received, objects of interest detected, and keypoints labeled, the back-end computer system 212 can generate a subsequent sequence, or incremented, value associated with such keypoints, which can serve as a new identifier associated with the newly labeled keypoint. The back-end computer system 212 can then apply, at step 312, a segmentation label that is tailored for the specific application. It shall be appreciated that, with image segmentation, each annotated pixel in an image belongs to a single class and that the labeling of image data can require a high degree of accuracy and can be manually intensive because it requires pixel-level accuracy. Accordingly, the present disclosure will address the application, at step 312, of a segmentation label in more detail in reference to FIG. 4 and will display masked output of the segment labeling, which outlines the shape of the strawberry 218ₐ₋ⱼ, in the image data, in FIG. 10A, which will be discussed in more detail. Furthermore, the segmentation label can include any number of segmenting means (e.g., semantic segmentation, instance segmentation, panoptic segmentation, etc.).

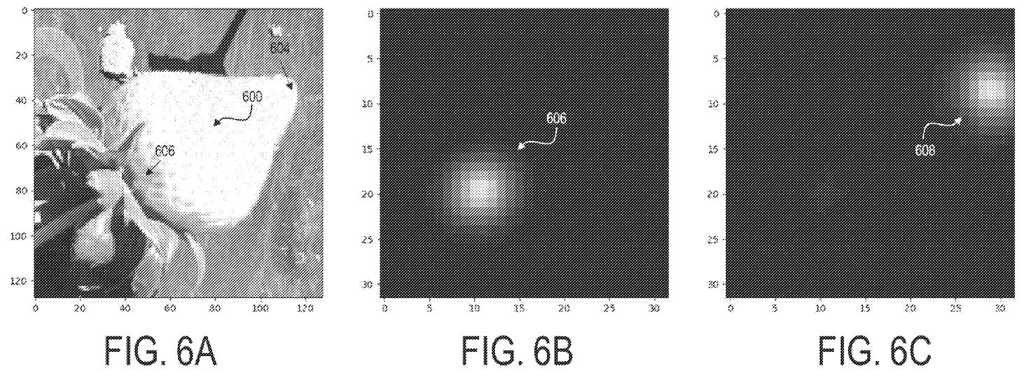

The method 300 can further include the application, at step 314, of an attribute label to the unlabeled strawberry 218ₐ₋ⱼ in the sensor data. For example, attributes such as a calyx or a tip of the strawberry can be identified and labeled by the back-end computer system 212 as such, as is depicted in FIGS. 6A, 10C, and 10D. Accordingly, the back-end computer system 212 can identify the general shape of the strawberry 218ₐ₋ⱼ via the segmentation labeling, at step 312, and can identify key attributes of the strawberry 218ₐ₋ⱼ via attribute labeling at step 314. Subsequently, the method 300 can include assessing, at step 316, whether or not the strawberry 218ₐ₋ⱼ) meets or exceeds a second threshold. For example, having already determined, at step 308, that the strawberry 218ₐ₋ⱼ is not emerging, the back-end computer system 212 can further assess, at step 316, a degree of ripeness of the unlabeled strawberry 218ₐ₋ⱼ), as depicted in certain illustrative charts 808, 810, 812 of FIG. 8.

If the strawberry 218ₐ₋ⱼ fails to meet or exceeds the second threshold criteria, the back-end computer system 212 will conclude that no additional labeling of the features of the strawberry 218ₐ₋ⱼ is required, and reassess, at step 304, whether any additional labeling is required. If not, the sensor data is transmitted 306 for review. In other words, the back-end computer system 212 can determine that the strawberry 218ₐ₋ⱼ, is not emerging, but still not ripe and thus, does not require labeling at step 318. However, assuming the strawberry 218ₐ₋ⱼ meets or exceeds the second threshold criteria (e.g., is ripe), the method 300 can further include labeling, at step 318, the strawberry 218ₐ₋ⱼ, as ready to be for picked.

It shall be appreciated the steps of the method 300 described herein is non-exclusive and merely exemplary. Accordingly, it shall be appreciated that the method 300 can be modified to include any of the functions discussed herein, as attributed with any of the components, devices, and/or systems described in reference to the non-limiting aspects of FIGS. 1 and 2.

Referring now to FIG. 4, a flow diagram of the segmentation labeling step 312 of the algorithmic method 300 of FIG. 3 is depicted in accordance with at least one non-limiting aspect of the present disclosure. According to the non-limiting aspect of FIG. 4, the segmentation labeling step 312 can include assessing, at step 402, an orientation of the strawberry 218ₐ₋ⱼ. If the strawberry 218ₐ₋ⱼ is imaged in a profile view, the back-end computer system 212 will apply, at step 406, a first segmentation label (e.g., a flesh_poly label), as illustrated in FIGS. 10A and 10B. However, if the strawberry 218ₐ₋ⱼ is imaged in an axial view, the back-end computer system 212 will further assess, at step 404, whether or not the strawberry 218ₐ₋ⱼ is imaged from the top or the bottom. If the strawberry 218ₐ₋ⱼ is imaged from the top, the back-end computer system 212 will apply, at step 408, a second segmentation label (e.g., a flesh_ellipse label), as illustrated in FIG. 10C. However, if the strawberry 218ₐ₋ⱼ is imaged from the bottom, the back-end computer system 212 will apply, at step 406, the first segmentation label (e.g., a flesh_poly label), as illustrated in FIG. 10D. Of course, the segmentation labeling step 312 of FIG. 4 can be attenuated to assess any number of views captured of an object of interest, and the labels can also be attenuated in accordance with user preference and/or intended application.

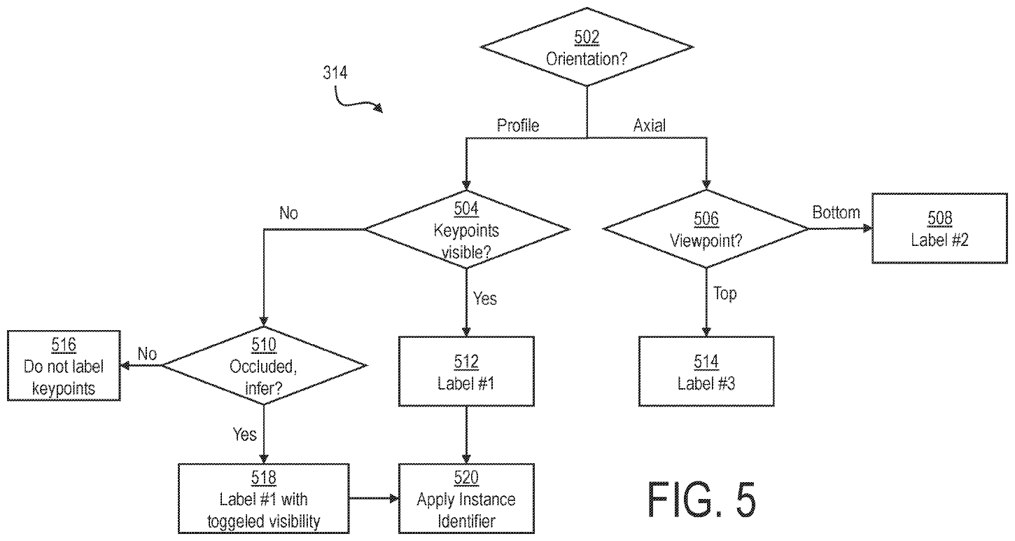

Referring now to FIG. 5, a flow diagram of the attribute labeling step 314 of the algorithmic method 300 of FIG. 3 is depicted in accordance with at least one non-limiting aspect of the present disclosure. Similar to the segmentation labeling step 312, according to the non-limiting aspect of FIG. 5, the attribute labeling step 314 can begin by assessing, at step 502, an orientation of the strawberry 218ₐ₋ⱼ. If the strawberry 218ₐ₋ⱼ is imaged in a profile view, the back-end computer system 212 can further assess, at step 504, whether any keypoints are visible. If it is determined that keypoints are visible, the back-end computer system 212 will apply, at step 512, a first attribute label (e.g., a flash_skelton label). If it is determined that no keypoints are visible, the back-end computer system 212 can assess, at step 510, whether any the strawberry 218ₐ₋ⱼ is occluded and whether any keypoints can be inferred. If it is determined that keypoints cannot be inferred, the back-end computer system 212 will not label, at step 516, any keypoints. However, if it is determined that keypoints can be inferred, the back-end computer system 212 can apply, at step 512, the first attribute label (e.g., a flash_skelton label), with a note for toggled visibility. Once keypoints have been labeled, the back-end computer system 212 can apply, at step 520, and/or increment an instance identifier.

According to the non-limiting aspect of FIG. 5, if the back-end computer system 212 determines, at step 502, that the strawberry 218ₐ₋ⱼ is imaged in an axial view, the back-end computer system 212 can further assess, at step 506, whether or not the strawberry 218ₐ₋ⱼ is imaged from the top or the bottom. If the strawberry 218ₐ₋ⱼ is imaged from the bottom, the back-end computer system 212 can apply, at step 508, a second segmentation label (e.g., a tip_keypoint label). If the strawberry 218ₐ₋ⱼ, is imaged from the top, the back-end computer system 212 can apply, at step 508, a third segmentation label (e.g., a calyx_keypoint label). Of course, the attribute labeling step 314 of FIG. 5 can be attenuated to assess any number of views and/or attributes associated with an object of interest, and the labels can also be attenuated in accordance with user preference and/or intended application.

Referring now to FIGS. 6A-C, several views of exemplary sensor data generated by the system 200 of FIG. 2 and attenuated by the method 300 of FIG. 3 are depicted in accordance with at least one non-limiting aspect of the present disclosure. According to the non-limiting aspect of FIG. 6A, unlabeled sensor data generated by one or more sensors (e.g., first sensor 114 and/or second sensor 116 of FIG. 1) of the robot 202 of the system of FIG. 2. For example, the captured sensor data can include image data of a strawberry 600 with a calyx 602 and a tip 604. The sensor data of FIG. 6A can be transmitted to a back-end computer system 212 for processing via the method 300 of FIG. 3. Alternately and/or additionally, a processor, such as processor 104 of FIG. 1, of the robot 202 of FIG. 2 can execute the method 300 of FIG. 3. Regardless, the method 300 of FIG. 3 recognizes that the sensor data includes an object of interest, such as strawberry 600, that has not been labeled. Specifically, the back-end computer system 212 can proceed to execute the segmentation labeling process 312 of FIG. 4 and the attribute labeling process 314 of FIG. 5, resulting in the identification of the strawberry 600, as well as certain attributes, including a calyx keypoint 606 and a tip keypoint 608. The labeled sensor data, as depicted in FIGS. 6A and 6B can subsequently be displayed via display 214 of FIG. 2 and, notably, transmitted back to the robot 202 of FIG. 2. Thus, the robot 202 can autonomously manipulate and control the robotic arm to pick the strawberry 600.

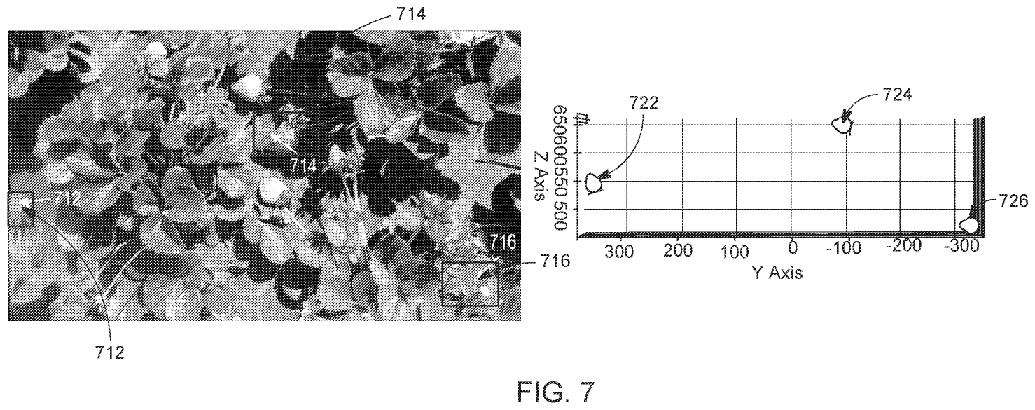

Referring now to FIG. 7, more sensor data generated by the system 200 of FIG. 2 and attenuated by the method 300 of FIG. 3 is depicted in accordance with at least one non-limiting aspect of the present disclosure. Similar to the sensor data depicted in FIGS. 6A-C, the sensor data of FIG. 7 juxtaposes unlabeled sensor data and labeled sensor data. However, according to the non-limiting aspect of FIG. 7, the sensor data can include data not just a single strawberry, but data indicating a plurality of strawberries 712, 714, 716 in a field that includes obscuring foliage and a canopy. Nonetheless, the back-end computer system 212 of FIG. 2 is able to execute the segmentation labeling process 312 of FIG. 4 to identify the strawberries 712, 714, 716 and the attribute labeling process 314 of FIG. 5 to label attributes of the strawberries 712, 714, 716. Accordingly, the back-end computer system 212 of FIG. 2 can produce corresponding strawberry keypoints 722, 724, 726 that are accurately positioned and oriented in the field, via the identification and labeling of attributes. The sensor data of FIG. 7 further models the strawberry keypoints 722, 724, 726 in a reference coordinate frame that includes (at least) a Z-axis and Y-axis, such that the robot can understand the position and orientation of the strawberries 712, 714, 716 relative to it's robotic arm and gripper. In other words, the robot 202 of FIG. 2 can simulate hand-eye coordination and thus, enhance its autonomous manipulation and control to pick the strawberries 712, 714, 716 in a precise, optimal, and/or delicate manner, as will be described in reference to FIGS. 11A-D.

Referring now to FIG. 8, a reference chart illustrating various training data for the back-end computer system 212 of the system of FIG. 2 is depicted in accordance with at least one non-limiting aspect of the present disclosure. According to the non-limiting aspect of FIG. 8, data corresponding to several charts 802, 804, 806, 808, 810, 812 can be provided the back-end computer system 212 (or alternately, an on-board processor of the robot 202 of FIG. 2), to assist in the labeling via the method 300 of FIG. 3. For example, data about the first chart 802 can inform the back-end computer system 212 as to whether the strawberry plant is flowering, a second chart 804 can inform the back-end computer system 212 as to whether the strawberry is emerging, and a third chart 806 can inform the back-end computer system 212 as to whether the strawberry plant has produced a strawberry that is unripe. Various attributes at each stage are illustrated by the charts 802, 804, 806, which can be used by the back-end computer system 212 to make the relevant determinations. Accordingly, data for the charts 802, 804, 806 can assist the back-end computer system 212 in assessing 308 (FIG. 3) whether the strawberry 218ₐ₋ⱼ, meets or exceeds the first threshold criteria.

Still referring to FIG. 8, data for a fourth chart 808 can inform the back-end computer system 212 as to whether the strawberry ripening, data for a fifth chart 810 can inform the back-end computer system 212 as to whether the strawberry is ripe, and data for a third chart 812 can inform the back-end computer system 212 as to whether the strawberry is overripe. Various attributes at each stage are illustrated by the charts 808, 810, 812, which can be used by the back-end computer system 212 to make the relevant determinations. Accordingly, charts 808, 810, 812 can assist the back-end computer system 212 in assessing 316 (FIG. 3) whether the strawberry 218ₐ₋ⱼ meets or exceeds the second threshold criteria.

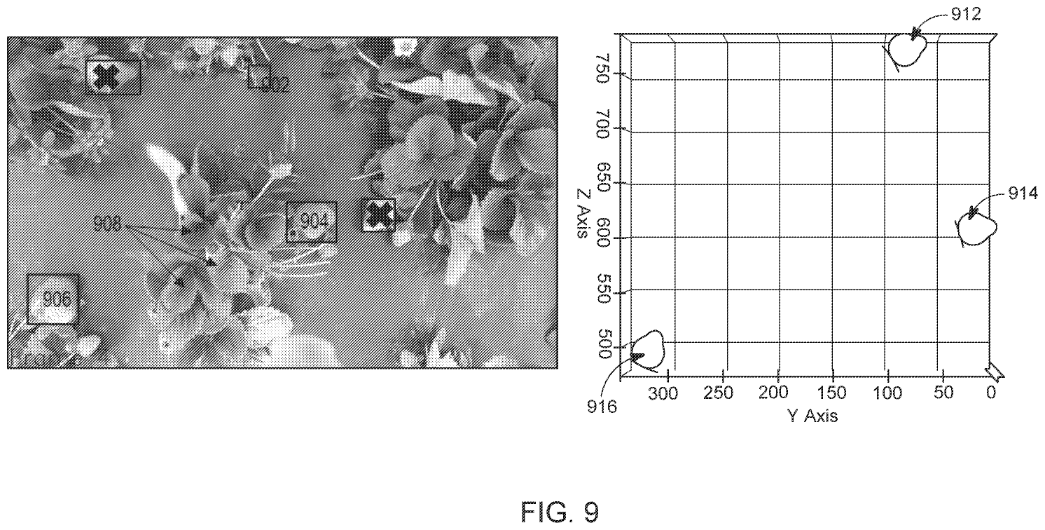

Referring now to FIG. 9, more sensor data generated by the system 200 of FIG. 2 and attenuated by the method 300 of FIG. 3 is depicted in accordance with at least one non-limiting aspect of the present disclosure. Similar to the sensor data depicted in FIG. 7, the sensor data of FIG. 9 juxtaposes unlabeled sensor data associated with a plurality of strawberries 902, 904, 906 in a field that includes obscuring foliage 908, and labeled sensor data. However, according to the non-limiting aspect of FIG. 9, the sensor data is applying training data, such as from the charts 802, 804, 806, 808, 810, 812 of FIG. 8, to select and model only ripe strawberries 902, 904, 908 to be picked by the robot 202 of FIG. 2. For example, the sensor data of FIG. 9 has only modeled strawberry keypoints 912, 914, 916 that correspond to strawberries 902, 904, 908 that satisfy the the first and second threshold criteria under steps 308 and 316 of FIG. 3. Accordingly, unacceptable strawberries X have not been labeled and have been omitted from the model. The acceptable strawberries 902, 904, 908 have once again been labeled and modeled as keypoints 912, 914, 916 in a reference coordinate frame that includes (at least) a Z-axis and Y-axis, such that the robot can understand the position and orientation of the acceptable strawberries 912, 914, 916 relative to it's robotic arm and gripper. In other words, the robot 202 of FIG. 2 can not only simulate hand-eye coordination, but can further discern which strawberries 902, 904, 908 in the field are worth picking and thus, can further enhance its autonomous manipulation and control to pick the acceptable strawberries 902, 904, 908.

Referring now to FIGS. 10A-D, more sensor data generated by the system 200 of FIG. 2 and attenuated by the method 300 of FIG. 3 is depicted in accordance with at least one non-limiting aspect of the present disclosure. Specifically, according to FIG. 10A, segmentation and relevant keypoint labeling has been overlayed onto the sensor data, providing a skeleton for the shape and relative orientation of the strawberry. It has been noted that the strawberry is partially occluded by foliage, and labeled accordingly. Also, instance identification numbers have been been applied, regardless of class. Four attribute keypoint labels have been applied. Attribute keypoint label 1 indicates the calyx, or the intersection of the stem with and estimated main body of the strawberry. Attribute keypoint label 2 indicates a point on the base of the strawberry that may or not be the tip, which was marked accordingly. Finally, Skeleton keypoint labels 3 and 4 indicate the widest point of the strawberry. Additionally, the flesh_poly label has been applied, indicating the main body of the strawberry, excluding the calyx.

In reference to FIG. 10B, sensor data associated with another strawberry in the field is depicted, with a leaf substantially occluding the calyx of the strawberry. An annotation indicating that the back-end computer system 212 of FIG. 2 can estimate the position of occluded keynotes, via step 510 of the attribute labeling process 314 of FIG. 5 has been provided. Accordingly, the back-end computer system 212 of FIG. 2 will likely label the estimated keynotes with the first attribute label and some reference to the occluded visibility. Accordingly, the robot 202 of FIG. 2 can first move the foliage and then pick the strawberry in accordance with the sensor data of FIG. 10B.

According to the non-limiting aspect of FIG. 10C, sensor data associated with another strawberry that has been assessed via step 404 of the segmentation labeling process 312 of FIG. 4 to determine whether or not the strawberry was imaged from the top or the bottom. In FIG. 10C, the back-end computer system 212 of FIG. 2 has determined that the strawberry was imaged from the top and thus, the back-end computer system 212 applied the second segmentation label (e.g., a flesh_ellipse label). Additionally, the back-end computer system 212 of FIG. 2 has applied 508 a third segmentation label (e.g., a calyx_keypoint label) via the attribute labeling process 314 of FIG. 5. Likewise, according to the non-limiting aspect of FIG. 10D, sensor data can be captured where the strawberry is imaged from the bottom. Accordingly, the back-end computer system 212 can apply the first segmentation label (e.g., a flesh_poly label), as illustrated in FIG. 10D. Notably, the strawberry of FIG. 10D has also been labeled as ripe, having met the first and second predetermined criteria, as described in reference to the method 300 of FIG. 3.

It shall be appreciated that the system 100 of FIG. 1 and method of FIG. 3 can be combined to enhance robotic manipulation and control in various applications, including the application 200 of FIG. 2. For example, it can be a struggle to pick crops that are ripe, especially when they are under canopy or obscured by un-ripened neighboring fruit. Specifically, certain crops may be delicate and prone to injury when being picked, which further complicates the process. Accordingly, the artificial intelligence and machine vision techniques disclosed herein can enable the robot 202 of FIG. 2 to execute more precise motions with an improved understanding of the relative position and orientation of the strawberries.

Referring now to FIGS. 11A-D, several block diagrams depicting an enhanced motion and control of the robotic arm 210 and gripper 212 of the robot 202 of FIG. 2 are depicted in accordance with at least one non-limiting aspect of the present disclosure. According to the non-limiting aspect of FIG. 11A, the system 100 of FIG. 1 has detected a strawberry 218 and labeled it via the method 300 of FIG. 3. Thus, the robotic arm 210 is being manipulated such that the gripper 212 is approaching the strawberry 218 from the tip, an attribute that has been identified and labeled via the process 314 of FIG. 5. According to FIG. 11B, the robotic arm 210 has successfully positioned the gripper 212 about the tip of the strawberry 218 such that the gripper can grip and manipulate the strawberry 218 for precise picking. Notably, other strawberries and flowers of the plant have been ignored, as they likely have not satisfied the first and second predetermined criteria, as described in reference to the method 300 of FIG. 3.

According to FIG. 11C, the robotic arm 210 and gripper 212 have manipulated the strawberry 218 such that a predetermined angle θ has been established between the stem 220 of the strawberry 218 and the shoulder of the strawberry. The predetermined angle θ can be an angle by which the least amount of force is required to remove the strawberry 218 from the plant and thus, can significantly reduce the risk of damage to the strawberry. According to some non-limiting aspects, the predetermined angle θ can be greater than or equal to five degrees and less than or equal to twenty-five degrees. However, according to other non-limiting aspects, where the object of interest is not a strawberry, other predetermined angles θ can be implemented according to user preference and/or intended application. It shall be appreciated that the method 300 of FIG. 3 enables the robot to have an improved understanding of its relative position to the strawberry 218 and thus, achieving such a precise predetermined angle θ is possible. After the predetermined angle θ is achieved, the robot 202 can apply a motion M, which according to some non-limiting aspects, may be rotational in nature, as depicted in FIG. 11D. Since the predetermined angle θ was achieved, the strawberry 218 is removed from the stem 220 of the plant with minimal force and thus, the risk of damaging the strawberry 218 is significantly reduced. According to some non-limiting aspects, two or more grippers 212 and/or robotic arms 210 can be implemented to increase productivity.

According to some non-limiting applications, the motions of FIGS. 11A-D can be accomplished via two arm-based motions, one to manipulate obscuring foliage and another motion to pick the strawberry 218. For example, a first sweep can move the foliage to expose the strawberry 218 by executing a “blind” motion based on location of plant and assumed bed height to get underneath leaves and expose a side of the plant, keep the strawberry 218 exposed (as much surface area as possible), and then execute a blind motion based on a location of the plant and an assumed bed height. A second sweep can account for leave height off bed (e.g., knowing not blind), and a third sweep can implement knowledge of the plant itself, which provides the maximum reveal of the strawberry 218. Directionality of the sweep motion (all levels) can be important to estimate strawberries 218 underneath. Alternately, specific leave sweeping (targeted sweeping, not full plant can be implemented. Some sweeps can involve a lateral and downward motion to press down into the plant and thus, stick the foliage parallel to the bed. Alternately, a curved motion instead of a straight line can be implemented.

It shall be further appreciated that, according to some non-limiting aspects, the robot 202 (FIG. 2), robotic arm 210, and/or gripper 212 can serve as objects of interest to the system 100 (FIG. 1), which can enhance position and orientation estimations via the method 300 of FIG. 3. For example, sensor data can be collected from one or more sensors 114, 116 (FIG. 1) mounted on or about the robot 202 (FIG. 2) Because the sensors 114, 116 (FIG. 1) are mounted at known, fixed locations and pointed along known vectors, sensor data generated by the sensors 114, 116 (FIG. 1) can be used to capture the full range of motion of the robotic arm 210 and/or gripper 212. The generated sensor data can then be processed via the method 300 of FIG. 3 to estimate the position and orientation of the robotic arm 210 and/or gripper 210 relative to the strawberry 218 and within the environment 201 (FIG. 2), or the field or farm being harvested. Thus, using the robotic arm 210, and/or gripper 212 as objects of interest to the system 100 (FIG. 1) can enhance and/or enable the motions illustrated by FIGS. 11A-D.

According to other non-limiting aspects, cluster manipulation can be achieved by one or two arms to expose the ripe berry enough to be picked by one of the standard motions. For example, the motions can include moving (without picking) a single strawberry to get clear access to a preferred strawberry 218. In other words, the robot 202 of FIG. 2 can move obstructions (e.g., green/red berries, foliage, etc.) to get to a preferred strawberry 218. Other motions contemplated by the present disclosure include one or two later directions, a “stir the pot” rotational motion, a “crochet” hook and grab, pulling via a mechanical finger or claw, the grabbing of strawberries to move them around, and/or a suction grabber. According to some non-limiting aspects the strawberries 218 can be picked in order of easiest to hardest.

In summary, the devices, systems, and methods disclosed herein take all sensor data and enhance the way it is implemented by robots in the real world. Thus, closed loop control robots is enabled and can be much less expensive due to improved data modeling of dynamics and control. The devices, systems, and methods are configured not only to visualize the object of interest (e.g., the fruit) but also obscuring environmental object (e.g., foliage), which can be displaced such that the robot can interact only with the object of interest. This assists the user in meeting or exceeding consumer expectations. This is opposed to conventional robots that used fixed motions to interact with objects of interest in fixed locations that do not change over time. Contrarily, the devices, systems, and methods disclosed herein enable the use of closed loop feedback to perform relative motions based on perception detection for applications where an object of interest's position can change over time. In other words, the feedback is closed-loop.

Examples of the method according to various aspects of the present disclosure are provided below in the following numbered clauses. An aspect of the method may include any one or more than one, and any combination of, the numbered clauses described below.

Clause 1. A system for enhanced robotic manipulation and control relative to an object of interest within an environment, the system including a robot configured to navigate the environment, the robot including a sensor configured to generate sensor data associated with the object of interest, and a robotic arm including an actuator, wherein the actuator is configured to cause the robotic arm to move relative to the object of interest, and a computer system communicably coupled to the robot, wherein the computer system includes a processor and a memory configured to store an algorithm that, when executed by the processor, causes the computer system to receive sensor data generated by the sensor, detect the object of interest based on the sensor data, determine whether the detected object of interest meets or exceeds a first threshold based on the sensor data, generate, upon determining that the object of interest meets or exceeds the first threshold, a label associated with a keypoint of the object of interest based on the sensor data, determine an orientation and scale of the object of interest in the environment relative to the gripper based on the generated label, generate a motion for the robotic arm based on the determined orientation and scale of the object of interest, and control the actuator of the robotic arm such that the robotic arm performs the generated motion.

Clause 2: The system according to clause 1, wherein the object of interest includes a strawberry.

Clause 3: The system according to either of clauses 1 or 2, wherein the generated label includes an attribute label including at least one of a calyx of the strawberry, or a tip of the strawberry, a shoulder of the strawberry, or a stem of the strawberry, or combinations thereof.

Clause 4: The system according to any of clauses 1-3, wherein the generated label includes a segmentation label including a masked output that outlines the shape of the strawberry.

Clause 5: The system according to any of clauses 1-4, wherein the segmentation label includes at least one of a semantic segmentation, an instance segmentation, or a panoptic segmentation, or combinations thereof.

Clause 6: The system according to any of clauses 1-5, wherein generating the label associated with a keypoint of the object of interest based on the sensor data includes determining an orientation of the strawberry based on the sensor data, determining a viewpoint of the strawberry based on the determined orientation of the strawberry, and applying an instance identification to the sensor data based on the determined orientation and viewpoint of the strawberry.

Clause 7: The system according to any of clauses 1-6, wherein, when executed by the processor, the algorithm further causes the computer system to determine whether the detected object of interest meets or exceeds a second threshold based on the sensor data, and wherein the label is further generated upon determining that the object of interest meets or exceeds the second threshold.

Clause 8: The system according to any of clauses 1-7, wherein determining that the object of interest meets or exceeds the first threshold includes a determination that the strawberry is not emerging.

Clause 9: The system according to any of clauses 1-8, wherein determining that the object of interest meets or exceeds the second threshold includes a determination that the strawberry is ripe.

Clause 10: The system according to any of clauses 1-9, wherein the robotic arm further includes a gripper configured to interact with the strawberry.

Clause 11: The system according to any of clauses 1-10, wherein performing the generated motion includes causing the gripper to establish a predetermined angle between a stem of the strawberry and a shoulder of the strawberry.

Clause 12: The system according to any of clauses 1-11, wherein the predetermined angle is greater than or equal to five degrees and less than or equal to twenty-five degrees.

Clause 13: The system according to any of clauses 1-12, wherein the predetermined angle is greater than or equal to ten degrees and less than or equal to sixteen degrees.

Clause 14: The system according to any of clauses 1-13, wherein the sensor includes at least one of a camera, a light detection and ranging (LIDAR) sensor, an ultrasonic sensor, or a radio detection and ranging (RADAR) sensor, or combinations thereof.

Clause 15: The system according to any of clauses 1-14, wherein the sensor includes at least one of a hyperspectral camera, high-resolution camera, a charge-coupled device (CCD) sensor, or a Complementary Metal Oxide Semiconductor (CMOS) sensor, or combinations thereof.

Clause 16: The system according to any of clauses 1-15, further including a vehicle configured to navigate the environment, wherein the robot is configured to be mounted to the vehicle and thus, navigate the environment by way of the vehicle.

Clause 17: The system according to any of clauses 1-16, wherein the computing system is positioned remotely relative to the robot.

Clause 18: The system according to any of clauses 1-17, wherein the computing system is positioned mechanically coupled to the robot.

Clause 18: A computer system configured to enhance manipulation and control of a robot, the computer system including a processor communicably coupled to the robot, and a memory configured to store an algorithm that, when executed by the processor, causes the computer system to receive sensor data generated by a sensor of the robot, detect an object of interest based on the sensor data, determine whether the detected object of interest meets or exceeds a first threshold based on the sensor data, generate, upon determining that the object of interest meets or exceeds the first threshold, a label associated with a keypoint of the object of interest based on the sensor data, determine an orientation and scale of the object of interest in the environment relative to the gripper based on the generated label, generate a motion for the robot based on the determined orientation and scale of the object of interest, and cause the robot to perform the generated motion.

Clause 19. The computer system according to clause 18, wherein the object of interest includes a strawberry, and wherein performing the generated motion includes causing a gripper of the robot to establish a predetermined angle between a stem of the strawberry and a shoulder of the strawberry.

Clause 20. The computer system according to either of clauses 18 or 19, wherein the predetermined angle is greater than or equal to five degrees and less than or equal to twenty-five degrees.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A system for enhanced robotic manipulation and control relative to an object of interest within an environment, the system comprising:
a mobile robot navigating the environment, the mobile robot comprising:
a sensor generating sensor data indicative of a physical attribute of the object of interest; and
a robotic arm comprising an actuator, wherein the actuator causes the robotic arm to move relative to the object of interest; and
a computer system communicably coupled to the mobile robot, wherein the computer system comprises a processor and a memory storing an algorithm that, when executed by the processor, causes the computer system to:
receive sensor data generated by the sensor;
detect the object of interest based on the sensor data;
determine whether the detected object of interest meets or exceeds a first threshold based on the sensor data;
generate, upon determining that the object of interest meets or exceeds the first threshold, a label associated with a keypoint of the object of interest based on the sensor data;
determine an orientation and scale of the object of interest in the environment relative to the robotic arm based on the generated label;
generate a motion plan for the robotic arm based on the determined orientation and scale of the object of interest; and
control the actuator of the robotic arm to cause the robotic arm to perform the generated motion plan.

2. The system of claim 1, wherein the object of interest comprises a strawberry.

3. The system of claim 2, wherein the generated label comprises an attribute label comprising at least one of: a calyx of the strawberry, a tip of the strawberry, a shoulder of the strawberry, or a stem of the strawberry.

3. (canceled)

4. The system of claim 2, wherein the generated label comprises a segmentation label comprising a masked output that outlines a shape of the strawberry.

5. The system of claim 3, wherein generating the label associated with a keypoint of the object of interest based on the sensor data includes:
determining an orientation of the strawberry based on the sensor data;
determining a viewpoint of the strawberry based on the determined orientation of the strawberry; and
applying an instance identification to the sensor data based on the determined orientation and viewpoint of the strawberry.

6. The system of claim 2, wherein, when executed by the processor, the algorithm further causes the computer system to:
determine whether the detected object of interest meets or exceeds a second threshold based on the sensor data; and
wherein the label is further generated upon determining that the object of interest meets or exceeds the second threshold.

7. The system of claim 6, wherein determining that the object of interest meets or exceeds the first threshold comprises a determination that the strawberry is not turning.

8. The system of claim 7, wherein determining that the object of interest meets or exceeds the second threshold comprises a determination that the strawberry is ripe.

9. The system of claim 2,
wherein the robotic arm further comprises a gripper interacting with the strawberry, and
wherein performing the generated motion comprises causing the gripper to establish a predetermined angle between a stem of the strawberry and a shoulder of the strawberry.

10. (canceled)

11. The system of claim 9, wherein the predetermined angle is greater than or equal to five degrees and less than or equal to twenty-five degrees.

12. The system of claim 9, wherein the predetermined angle is greater than or equal to ten degrees and less than or equal to sixteen degrees.

13. The system of claim 1, wherein the sensor comprises at least one of; a camera, a light detection and ranging sensor, an ultrasonic sensor, or a radio detection and ranging sensor.

14. The system of claim 1, wherein the sensor comprises at least one of: a hyperspectral camera, high-resolution camera, a charge-coupled device sensor, or a complementary metal oxide semiconductor sensor.

15. The system of claim 1, wherein the mobile robot further comprises a vehicle navigating the environment, wherein the robotic arm is mounted to the vehicle.

16. The system of claim 1, wherein the computing system is positioned remotely relative to the robot.

17. The system of claim 15, wherein the computing system is mounted to the vehicle.

18. A computer system configured to enhance manipulation and control of a robot, the computer system comprising:
a processor communicably coupled to the robot; and
a memory storing an algorithm that, when executed by the processor, causes the computer system to:
receive sensor data generated by a sensor of the robot;
detect an object of interest based on the sensor data;
determine whether the detected object of interest meets or exceeds a first threshold based on the sensor data;
generate, upon determining that the object of interest meets or exceeds the first threshold, a label associated with a keypoint of the object of interest based on the sensor data;
determine an orientation and scale of the object of interest in an environment relative to a gripper of the robot based on the generated label;
generate a motion for the robot based on the determined orientation and scale of the object of interest; and
cause the robot to perform the generated motion.

19. The computer system of claim 18, wherein the object of interest comprises a strawberry, and wherein performing the generated motion comprises causing the gripper of the robot to establish a predetermined angle between a stem of the strawberry and a shoulder of the strawberry.

20. The computer system of claim 19, wherein the predetermined angle is greater than or equal to five degrees and less than or equal to twenty-five degrees.

21. The system of claim 4, wherein the segmentation label comprises at least one of: a semantic segmentation, an instance segmentation, or a panoptic segmentation.
